(19) United States
(12) Patent Application Publication
(10) Pub. No.: US 2010/0215556 A1
(43) Pub. Date: Aug. 26, 2010

(54) NANOPORE REACTIVE ADSORBENTS FOR THE HIGH-EFFICIENCY REMOVAL OF WASTE SPECIES

(75) Inventors: Roman Domszy, Lancaster, PA (US); Yun Han Lee, Mountville, PA (US)

Correspondence Address: Industrial Science & Technology Network, Inc, 2101 Pennsylvania Avenue, York, PA, 17404, US

(73) Assignee: INDUSTRIAL SCIENCE & TECHNOLOGY NETWORK INC., York, PA (US)

(21) Appl. No.: 12/447,891

(22) PCT Filed: Oct. 31, 2007
(86) PCT No.: PCT/US2007/023069

§ 371 Date: Apr. 29, 2009

Related U.S. Application Data
(60) Provisional application No. 60/856,017, filed on Nov. 2, 2006.
(60) Provisional application No. 60/856,034, filed on Nov. 2, 2006.

(51) Int. Cl. B01J 20/02; C02F 1/42; B05D 7/00; C22B 11/00; C22B 3/00; C22B 13/00; A62D 3/33; B09C 1/08

(52) U.S. Cl. 423/22; 210/688; 427/419.2; 502/405; 423/1; 423/89; 423/25; 423/24; 423/99; 423/100; 588/315; 405/128.75

(57) ABSTRACT

A nanopore reactive adsorbent composite material, which may be a porous adsorbent comprising a chemically surface face modified gel, has a composition and micro structure, which integrals ion exchange components such as hydroxy apatite.

### CROSS REFERENCE TO RELATED APPLICATIONS

This application claims the benefit of both U.S. Provisional Application No. 60/856,017, filed Nov. 2, 2006, and U.S. Provisional Application No. 60/856,034, tiled Nov. 2, 2006. Both provisional applications, in their entirety, are incorporated herein by reference.

### FIELD OF THE INVENTION

This invention relates to nanoporous reactive adsorbents and to the use thereof in removing impurities from liquids. More particularly, this invention relates to silica based nanoporous adsorbents having very high density of chemically surface modifying ligands further modified to include chemically reactive species and to the use thereof for purifying contaminated liquids.

### BACKGROUND OF THE INVENTION

The most common method of removing waste species from a liquid stream is by adsorption. Such a method can be applied to water purification in a continuous operation with water flowing through a column or over a fixed bed of the solid adsorbent. Commercial ion-exchange resins and carbon black filters are examples of this approach.

The common characteristics of an efficient adsorbent include a large surface area and connected (i.e. open) porous structure for fast diffusion. Recent developments in this technical field include the incorporation of molecular recognition functional species (i.e. metal-binding ligands) onto the surface of various inorganic or organic carrier materials to achieve the selective adsorption of a particular group of ions out of the background ions. Among all the carrier materials explored in this developmental field, the synthetic silica gel is the most widely studied. This is because the synthetic nanoparticle silica contains a large amount of active silanol groups on its surface, necessary for the incorporation of metal-binding ligands, and has an exceptionally high surface area as well as open porous structure, necessary for achieving a rapid high-capacity adsorption.

Although much prior art has been developed based on the identical principle of incorporating metal-ion binding functional groups onto the surface of nanopore silica, the characteristics of the resulting silica-ligand composite products may differ significantly depending on the routes of processing.

Different processing techniques may start with silica gels similar in porosity and specific surface area (surface area per gram of silica) but could end up with products of distinctly different loading of the ligand groups. Or, two composites may contain a similar amount of loading of functional groups and yet differ considerably in adsorption efficiency.

One of the present inventors has recently developed an advancement in technology of the surface modification of low-density silica gel (CSMG) which can produce high surface area silica with extremely high loading of functional groups that increases the adsorption efficiency and capacitance of the silica adsorbent to a significantly higher level; this technology is the subject matter of U.S. application Ser. No. 09/601,888, filed Aug. 9, 2000, based on Provisional Application Ser. No. 60/074,026, filed on Feb. 9, 1998 and International Application PCT/US99/02181, filed Feb. 3, 1999, the disclosures of which are incorporated herein in their entirety by reference.

The present inventors recognized that a high-capacity adsorption may lead to a much higher concentrated environment of adsorbed species on the surface of an adsorbent when compared with the species concentration in the passing stream. Such increased species population density on the pore surface could significantly increase the reaction rate of the adsorbed species with other reactives existing nearby. Moreover, the change in the electronic state of adsorbed species during chemisorptions could also affect its reaction rate favorably. The adsorbent, therefore, could function as a heterogeneous catalyst for the chemical reaction of adsorbed species. If the adsorbed waste species can be converted to a less harmful or even useful species by such a reaction, the adsorbent then becomes a reactive adsorbent. The additional option of in-situ reaction to convert the adsorbed species provided by a reactive adsorbent can significantly increase its treatment capacity because the converted waste species normally do not occupy the surface adsorption sites any longer. The present invention is based, in part, on the recognition and utilization of the foregoing considerations.

Lead contaminations, in particular, portray a serious threat to the environment and public health. Lead is highly toxic, easily absorbed, and persistently retained by the body, resulting short- and longer-term health hazards. Lead may cause behavioral problems, learning disabilities, seizures or death. Exposure to lead may occur form the presence of lead-based paint, plumbing fixtures as well as contaminated groundwater near mining, weaponry, or industrial waste sites.

The current remediation of lead-contaminated water, particularly when lead concentration is low, presents serious technical challenges. Normal processing would involve the sequential precipitation, coagulation and filtration of lead compound. This process is tedious, slow and costly. Moreover, the disposal of the final lead concentrates could still be troublesome. One emerging scientific field that demonstrates great promise in being able to resolve the shortcomings of existing Lead treatment is nanotechnology. Virtually all treatment technologies for lead currently have shortcomings that could be substantially improved by nanotechnology.

### SUMMARY OF THE INVENTION

This invention has been accomplished by embedding reactive species into the structure of a nanopore adsorbent in order to convert waste or undesirable species in situ during filtration as well as to increase the treatment capacity of the adsorbent towards a specific waste species and/or recoverable species having intrinsic value.

Thus, for example, the present invention, in one particular embodiment, provides for treating heavy metal ions in a waste stream. However, this invention may also be extended to other reactive adsorption applications by appropriate selection of the embedded reactive species.

In another aspect of the invention, there is provided a regeneration scheme that utilize the reactive nature of the nanopore adsorbent by applying backwash effluent repetitively through the reactive adsorbent to first remove the adsorbed species and then react them with the reactive component embedded within the adsorbent. Such a regeneration scheme does not require additional treatment of the backwash effluent and is hereby given the name of close-end regeneration.

The above features of the present invention are accomplished according to one embodiment of the invention by a composite nanopore reactive adsorbent comprising a continuous phase comprised of adsorbent particles and interstitial pores therebetween, and

a phase comprised of reactive particles contained in domains surrounded by the adsorbent particles and their interstitial pores, thereby forming an intimate admixture of adsorbent particles, reactive particles and interstitial pores,

wherein the size of the reactive particles is at least several times larger than the size of adsorbent particles such that the interstitial pores predominantly reside with the adsorbent particles, and

wherein the relative volume fraction of the interstitial pores in the continuous phase to that of the adsorbent particles is larger than the percolation threshold value so that the continuous phase contains connected open pores.

Preferably, in the above nanopore reactive adsorbent, the adsorbent particles are formed from precipitated silica or the adsorbent particles comprise chemically surface modified amorphous silica gel. In a preferred embodiment of this aspect of the invention, the reactive particles are comprised of an in-situ ion exchange agent, such as, for example, hydroxyapatite (HA) crystals or particles.

According to another aspect, the present invention provides a method for producing the composite nanopore reactive adsorbent as described above, comprising:

(a) reacting an inorganic metal oxide nanoporous gel precursor characterized by a plurality of open channels within the gel structure and hydroxyl reactive groups on the surface thereof, with a coupling reagent reactive with said hydroxyl reactive groups, in an aqueous alcoholic medium under an inert atmosphere and at an elevated temperature within the range of from about 40° C. to about 80° C. to cause the coupling reactive to condense and react with said hydroxyl reactive groups to form a grafted metal oxide sol;

(b) mixing and stirring the grafted silica sol with reactive particles; and

(c) gelling the stirred mixture from step (b).

In the above method, the gel precursor may comprise a silica gel precursor or the gel precursor may comprise an oxide of a metal selected from the group consisting of silicon, zirconium, aluminum, titanium, iron and lanthanum.

In accordance with still another aspect of the invention, there is provided a method for separating an inorganic or organic target species (e.g., a metal such as lead or the like) from a liquid containing the target species, which comprises contacting the liquid with a nanopore reactive adsorbent having a bound or embedded (e.g., within the interstitial pores thereof) reactive species. For example, in the case where the target species comprises lead ions, the reactive component can comprise hydroxyapatite (HA) particles (e.g., synthetic HA crystals), whereby the adsorbed lead ions are reduced by the HA particles to metallic lead. The recovered species, e.g., lead metal, will preferably be recovered from the adsorbent.

In a particularly preferred embodiment of this aspect of the invention the nanopore reactive adsorbent is present in or as a filter medium.

According to still another aspect of the invention, there is provided a closed end regeneration method which comprises adsorbing a species from a starting liquid containing the species by contacting the liquid with a nanopore reactive adsorbent comprising connected interstitial pores having adsorption sites on the surfaces thereof, and containing among the interstitial pores thereof reactive component which is reactive with said species, to thereby remove at least some of said species from said liquid, thereby forming spent adsorbent; flowing a treating liquid through the spent nanopore reactive adsorbent to remove adsorbed species from said adsorption sites and partially regenerate said reactive component, thereby generating effluent treating liquid, and reflowing said effluent treating liquid through the treated spent nanopore reactive adsorbent at least once to regenerate said adsorption sites and said reactive component.

In another embodiment, there is provided an adsorbent composition comprising a chemically surface modified gel; and at least one reactive component comprising at least one hydroxyapatite (HA) crystal, HA particle, or component comprising HA.

In another embodiment, there is provided a method of recovering a metal ion (e.g., lead, copper, cadmium, mercury) from a fluid, comprising contacting the fluid with the adsorbent HA/CSMG composition described herein.

In another embodiment, there is provide a method of treating lead-containing waste under a near neutral pH (i.e. between 6-8) condition, comprising contacting the waste with the adsorbent HA/CSMG composition described herein.

In yet another embodiment, there is provided a method of treating lead ions in effluent waste, following the precipitation of Pb(OH)₂ by a strong base, comprising contacting the waste with the adsorbent I-IA/CSMG composition described herein.

In yet another embodiment, there is provided a method of stabilizing Pb(OH)₂ precipitate at a site (such as from a landfill or an abandoned mine site), comprising contacting at least a portion of the site with the adsorbent HA/CSMG composition described herein. In yet another embodiment, there is provided a method of preventing lead ions from leaching from a site, comprising contacting at least a portion of the site with the adsorbent HA/CSMG composition described herein.

In another embodiment, there is provided a method of preventing lead ions from leaching from a site, comprising contacting at least a portion of the site with the adsorbent HA/CSMG composition described herein.

In another embodiment, there is provided a method for at least partially immobilizing lead ions in or on soil and/or maintaining a neutral soil condition, comprising contacting the soil with the adsorbent HA/CSMG composition described herein.

In another embodiment, there is provided a method for forming a reactive barrier to prevent lead ions from diffusing into water streams or plant roots, comprising using the adsorbent HA/CSMG composition described herein.

In another embodiment, there is provided a method for removing heavy metal ions from tap or drinking water, comprising contacting the water with the adsorbent HA/CSMG composition described herein.

In another embodiment, there is provided a method for forming a reactive barrier coating over lead paint and preventing lead ion leaching from the paint, comprising contacting at least a portion of the paint with the adsorbent HA/CSMG composition described herein.

In another embodiment, there is provided a method for recovering metal ions from a low-concentration, spent solution by using nanopore reactive adsorbent of which the reactive component is composed of inert electrodes and the adsorption component is a CSMG nanopore substrate coated on the electrode; wherein at least one ligand in the CSMG coating adsorbs and/or catalyzes the nucleation of a metal ion.

### BRIEF DESCRIPTION OF THE DRAWINGS

FIG. 1 is a schematic diagram of a structure of a composite material according to an embodiment of the invention.

FIG. 2 illustrates isotherms of Pb(II) onto HA powders at pH 5 and 25° C. as a function of time.

FIG. 3 illustrates a batch test of CSMG-HA, in contact with 6.6 μm Pb(II).

FIG. 4 illustrates a batch test of CSMG-HAPHA, in contact with 590 ppm Pb(II).

### DETAILED DESCRIPTION OF THE INVENTION

A wet low-density silica gel normally contains a porous open-cell structure. Water flows and ions diffuse freely within this kind of open structure. Thus, the entire surface area of the pores can be accessed rapidly. The open porous structure will increase the efficiency and speed of ion adsorption in a water treatment operation. In addition, such an open structure is necessary for the incorporation of large functional groups onto the entire surface. Without an open structure, the incorporation of the functional groups in the preparation of the silica-ligand composite and the binding of targeted ions onto those ligands in a treatment operation become extremely slow and inefficient. Much prior art attempted to graft various ligand groups onto the surface of porous silica for ion-specific adsorption. However, because of the inefficiency, the loading and adsorption capacities of those ligands were consistently lower than 1 mmole per gram of silica.

The aforementioned new class of surface-modified low-density silica gel (CSMG), as described in the aforementioned U.S. Ser. No. 09/601,888 and PCT/US99/02181, is produced by chemically modifying a freshly produced (i.e. gelled without prolonged aging) silica gel still in its wet state with molecular recognition ligand groups. This new class of silica-ligand composite, CSMG, has a characteristic open pore structure, as well as an exceptional high loading of surface ligands, both resulting from controlling the interfacial energy and processing kinetics during its preparation. Compared with existing art in the field, CSMG differs in the following four categories:

(1) Composition: much higher loading of ligands (7.5 mmole per gram of support),

(2) Morphology: open channels connecting micro- and nanopores,

(3) Adsorption efficiency: majority of the loaded ligands are accessible,

(4) Processing efficiency: significantly reduced processing time,

(5) Solvent systems of processing: environmentally benign solvents.

As described in the aforementioned applications, the surface density of fully dense monolayer coverage for CSMG was estimated to be 5.times.10.sup.18 molecules per square meter of surface area. The ligand loading percentage on the silica surface achieved is close to 100%, based on the loading of 7.5 mmole ligand per gram of silica, (for a specific surface area of 900 m.sup.2/g silica). It is readily apparent that the utilization of the surface ligands of the CSMG for binding metal ions is far more efficient, e.g., rapid and complete, than achieved with prior art silica particles. For instance, adsorption tests done by mixing adsorbent with waste solution for one hour indicated a utilization of the surface ligand group is greater than about 50% for the CSMG used in the present invention, as compared to at most, about 25% for the prior art silica particles. It is presumed that in CSMG, the dense ligand groups, randomly distributed on the convex particle surfaces, are spreading outward and are more accessible for binding metal ions from the solution.

The metal ion adsorption capacity of the CSMG (140 mg adsorbent in 200 ml solution, for 1 hour, pH 23) as previously reported in Ser. No. 60/074,026, was as follows:

| | Capacity (mg/g) |
|---|---|
| Ag⁺ | 707 |
| Pb²⁺ | 253 |
| Hg²⁺ | 737 |
| Cu²⁺ | 243 |

These data demonstrated that the metal ions adsorbed on the CSMG surface (concentration approx. 5×10¹⁸ molecules per square meter) are far more condensed than the population in the waste stream (estimated as 10¹⁶ molecules per square meter cross sectional area for part per thousand waste concentration). If there are other species reactive to the metal ions existing near the surface of the adsorbent, the condensed state resulting from the strong surface adsorption is likely to increase the reaction rate significantly.

The present invention takes advantage of the high adsorbed metal ion concentration by intermixing, as described below, at least one reactive component with adsorbent particles. The reactive component, in this regard, can be a compound, for example, an ion exchange agent, that elutes metals or metal ions (e.g., Pd, ^{Pd2+}) from a fluid (e.g., water). In particular, for example, hydroxyapatite is a reactive component.

The composition as well as the microstructure according to this invention contains at least three different phases: adsorbent particles, reactive component and interstitial pores. The reactive component can comprise reactive particles of any suitable size. In particular, for example, the size of the reactive particles can be at least several times larger than the size of adsorbent particles so that the interstitial pores are predominantly residing with the adsorbent particles. (The smaller particles and their interstitial pores fill the interstitial region of the larger particles.) The total volume fraction of the larger particles is controlled so that the larger particles are in domains surrounded by smaller particles and their interstitial pores. In the continuous phase composed of the smaller particles and their interstitial pores, the relative volume fraction of the pores to that of the smaller particles is larger than the percolation threshold value so that the continuous phase contains connected open pores. The material disclosed in this invention with the described unique composition and microstructure is hereafter referred to as the Nanopore Reactive Adsorbent.

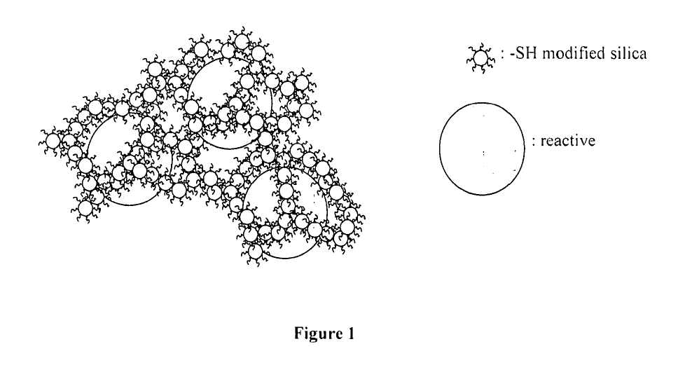

FIG. 1 is an illustration of an embodiment of this concept wherein the reactive component is illustrated as comprising particles that are encapsulated or embedded by the adsorbent particles, with interstitial pores existing therebetween. In this illustrated embodiment, the larger reactive particles are embedded within the continuous phase substantially as isolated or discontinuous phases.

Because the size of silica particles and pores in a CSMG is in the range of several to about ten nanometers, it is possible to embed a large amount of micron-sized (or larger) solid particles of a reactive component into the gel structure without blocking the flow and diffusion of the liquid stream that carries the waste species. As long as one continuous phase of such a composite is composed of the nanopore silica, the liquid can flow around these embedded particles through the open channels within the silica phase.

The presence of a reactive component in the condensed solid state near the pore surfaces that are already adsorbed with a dense layer of the second reactive species creates the opportunity for a rapid reaction between the two species. Enclosing the solid reactive component with the nanopore silica immobilizes the solid reactive component phase, thus, for example, facilitating use within a filtration column. The increased reaction rate as well as the prolonged residence time of the reactive waste species due to surface adsorption allows a high degree of reaction during a filtration treatment of a waste species or other desirable or undesirable species for recovery or discharge of the species and/or discharge of the treated liquid. For example, according to a specific embodiment of the present invention synthetic hydroxyapatite (HA) crystals or particles are embedded in a CSMG or precipitated silica or other metal oxide adsorbent to enhance the capacity of adsorbing lead ions from a fluid or medium. The CSMG adsorbent, due to the high loading of mercaptan containing functional groups, can adsorb high amounts of lead ions and reduce its concentration in a fluid to parts per million or parts per billion with a single treatment. The embedded HA particles can react with the surface-adsorbed lead ions and reduce them to lead metal. Because of the increased reactivity by dense surface adsorption, the chemical reaction can occur during the filtration process, leaving the lead metal deposits within the CSMG column. The reduction of lead ion to metal form deposited within the column is beneficial to the treatment in at least three ways:
1) the lead ions being reduced to metallic form, are ready for recovery;
2) the metal lead particles are highly condensed and can be deposited in large quantities within the filtration column; and
3) the lead ions adsorbed on the CSMG surface are reduced to metal, releasing the surface active site for further adsorption and increasing the capacity of waste treatment.

In another embodiment, the present invention provides a composite recovery system made by encapsulating chitosan polymer with surface modified colloidal nanoparticles. According to this embodiment, in-situ gelation of surface modified silica particles (such as disclosed in commonly assigned copending application Ser. No. 09/601,888, tiled Aug. 9, 2000, and Ser. No. 10/110,270, filed Sep. 30, 2002, the entire disclosures of which are incorporated herein by reference), in the presence of chitosan, creates an interpenetrating network of silica and chitosan macromolecules. As discussed more fully below, the composite recovery system additionally, in some embodiments, can comprise at least one reactive component (e.g., synthetic HA crystals) that is bound to or embedded within the composite.

In another embodiment, lead ions can first be captured by adsorption on the surface of HA crystals, regenerated to a more concentrated batch, and then reduced to bare metal by a CSMG-coated electrode in an electrolytic reactor. In this regard, a CSMG coated electrode can be use in the electrolytic recovery of heavy and precious metal to accomplish synergy that is comparable to that of HA-embedded CSMG, but with a longer service life.

In another embodiment, lead ion containing wastes can be treated directly with synthesized HA powder or with HA embedded adsorbents in a manner that results in a neutral discharge after treatment, and that spares less Pb²⁺ ions in the supernatant. Lead adsorbed with HA, as compared to Pb(OH)₂, in this regard, can be disposed into landfills with less concerns. Moreover, it is less vulnerable to acidic attacks due to sacrificial releasing of calcium ions from HA in acidic environments. (The solubility constants of Pb(OH)₂, Ca₃(PO₄)₂, and Ca₃(PO₄)₂ are 1.43×10⁻²⁰, 2.07×10⁻³³, and 2×10⁻⁴³, respectively.)

In another embodiment, synthesized HA can be spread directly or indirectly onto lead polluted soils (such as abandoned mine sites or lead bullet shooting ranges) to immobilize toxic lead ions while maintaining a neutral soil condition. In other embodiments, HA powders can ould be utilized as reactive barriers to prevent diffusion of lead ions from toxic waste sites. In another embodiment, grass could be grown on lead contaminated soils that are treated with synthesized HA. The capillary adsorption from the grass roots could bring up the water level through the HA barrier and thereby removing lead ions trapped down below.

The following examples illustrate this embodiment of the present invention.

### EXAMPLES

### Producing Hydroxypapatite (HA) for Lead Adsorption

In one embodiment, HA is produced in a manner such that it is characterized by low crystallinity associated with nanometric crystal size and also the incorporation of carbonated species.

A low cost option for scale-up synthesis of HA entails slowing neutralizing a slurry of calcium hydroxide with phosphoric acid. This route also minimizes the washing steps. In some embodiments, carbonated HA is desirable.

Two common methods of preparing HA are described in the reaction schemes A and B. The reaction scheme A is the reaction between calcium nitrate and ammonium dihydrogen phosphate' and the reaction scheme B is the reaction between calcium hydroxide and ortho-phosphoric acid.^{2 3} Lopez-Macipe, A.; Rodriguez-Clement, R.; Hidalgo-Lopez, A.; Arita, I.; Garcia-Garduno, M. V.; Rivera, E.; Castano, V. M. J. Mater. Synth. Process. 1998, 6, 21-26.² Osaka, A.; Minara, J.; Takenchi, K.; Asada, M.; Takahashi, K. J. Mater. Sci.: Mater. Med. 1991, 2, 51-55.³Milenko Markovic et. al. J. Res. Natl. Inst. Stand. Technol. 109, 553-568 (2004)

(A) 5Ca(NO₃)₂+3(NH₄)₂HPO₄+4NH₄OH Ca₅(PO₄)₃(OH)+3H₂O+10NH₄NO₃

(B) 5Ca(OH)₂+3H₃PO₄→Ca₅(PO4)₃(OH)+9H₂O

### Example 1

Using reaction scheme A, the synthesis was carried out at 40° C. using a 3M concentration of reagents.

A solution of 5.37 g of ammonium hydrogen phosphate (AHP) in 12 g of water was prepared and heated to 40° C. Aqueous ammonia was added until the pH and the solution was 10.0-10.5. A solution of 16 g of calcium nitrate tetrahydrate (CNT) in 18 g of water was prepared in a round-bottom flask equipped with a mechanical stirrer. The CNT solution was heated to 40° C. and aqueous ammonia was added to raised the pH to between 10.0 and 10.5. The AHP solution made previously was added drop-wise to the CNT solution while monitoring and adjusting the pH to 10. A cloudiness in the solution appeared after about 2 to 5 minutes indicating a formation of precipitants. After the addition of AHP solution, the suspension is then aged at 40-45 C for 12 hours. After aging the suspension is centrifuged and the supernatant removed by decanting the solution. The HA slurry was then repeatedly washed with water and centrifuged until the pH of the supernatant was 7. The centrifuged HA paste had a solids content of 35 wt. %.

### Example 2

Using reaction scheme B, the synthesis was carried out at 100° C. using a 2M phosphoric acid solution added at a rate of 1 ml/min.

Calcium hydroxide 300 g (4.057 mol) powder (minimum purity 96 wt %, Fluka/Aldrich 21181 or similar) was added to a 4 L glass reactor equipped with an electric stirring paddle, a reflux condenser and ports for introducing the acid and a thermal couple. Approximately 2.5 L of deionized water was added to the reactor and the mixture was well stirred and heated to 95-99C using a heating mantle controlled by a thermocouple placed in the reactor. A 2M solution of phosphoric acid was prepared by diluting 280 g of ˜85% phosphoric acid (H₃PO₄, reagent grade) with 1.22 L of water. The solution was pumped into the calcium hydroxide slurry at a rate of 1 mL/min and to a final Ca/P molar ratio of 1.67. The pH of the mixture remains above 11 until ˜100 ml of phosphoric acid remained. Addition of the acid was halted once the pH of the mixture reached ˜6. The addition of the acid took 23 hours.

The stirred reacting mixture was heated for another 24 hour. The precipitated solid phase was allowed to settle (1-2 hours) the supernatant decanted, and an equal volume of deionized water was added. This suspension was heated under reflux for another 4 hours and that these washing and refluxing procedures were repeated once more.

### Example 3

Using reaction scheme B, the synthesis was carried out at 40° C. using 2M phosphoric acid solution added at a rate of 1 ml/min.

Calcium hydroxide powder (293.1 g, 3.955 mol) of (minimum purity 96 wt %, Fluka/Aldrich 21181 or similar) was added to a 4 L three necked glass flask equipped with an electric stirring paddle, a reflux condenser and ports for introducing titrant and a thermal couple. Approximately 2400 ml of deionized water was added to the reactor and the mixture was well-stirred. The slurry was stirred for 3 hours before the H₃PO₄ solution was added. A 2M solution of phosphoric acid was prepared by diluting 273 g of ˜85% phosphoric acid (H₃PO₄, reagent grade) with 1186 ml of water. The solution was pumped into the calcium hydroxide slurry at a rate of 1 mL/min and to a final Ca/P molar ratio of 1.67. After ˜10 ml of acid was added, the calcium hydroxide suspension started to show an increase in viscosity. Addition of the acid was halted once the pH of the mixture reached ˜6.5. The addition of the acid took 20 hours.

The stirred reaction mixture was aged at room temperature for another 24 hours. The precipitated solid phase was allowed to partially settle (6 hours), the supernatant decanted, and an equal volume of deionized water was added. The precipitate was allowed to settle again (and the supernatant removed by use of the peristaltic pump. The HA slurry from this example was used directly in the production of the chitosan beads.

### Example 4

Using reaction scheme B, the synthesis was carried out at 40° C. using the same procedure described in Example 3 except the 2M phosphoric acid solution was added at a rate of 5 ml/min. In this example, the addition of acid was complete after 4 hours.

### Example 5

Using reaction scheme B, the synthesis was carried out at 40° C. using the same procedure described in Example 3 except the 2M phosphoric acid solution was added at a rate of 10 ml/min. In this example, the addition of acid was complete after 2 hours.

### Capacity and Efficiency

The ability of the HA slurry to remove Pb⁺² ions from solution is followed using flame atomic absorption spectroscopy (AAS). A solution of lead nitrate in water was prepared with an approximate Pb content of 600 ppm. The pH of the solution was 5. The solids content of the HA slurry was determined by evaporating the water at 110° C. The HA slurry was mixed with Pb solution with an approximate mass ratio of 1:2500 (dried HA:Pb Solution). The HA is well dispersed in the solution and for the measurement, the mixture is centrifuged (2000 rpm, 15 min) and a small amount is sampled for measurement with the AAS. After sampling, the HA was redispersed into the Pb solution by vigorous shaking. The amount of Pb removed is normalized by calculating the mmol/g (dry HA).

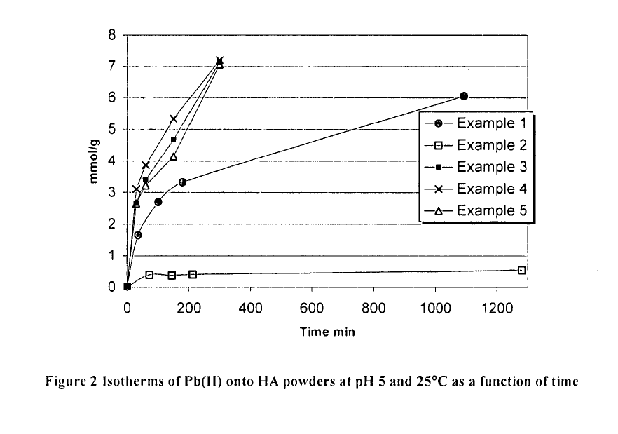

The performance of the HA powder made using reaction scheme B varied strongly with the temperature used in the synthesis. The optimum temperature was 40° C. Suitability for scale-up is also an important consideration. Scheme (B) requires less washing steps since there are no byproduct salts produced. FIG. 2 illustrates the isotherms of Pb(II) onto HA powders at pH 5 and 25° C. as a function of time.

### Method to Produce Silica-Chitosan Nanocomposite

A silica-chitosan nanocomposite is made from 3 ml of silicic acid obtained from an ion-exchange process (see experimental design section) and 1.5 ml 2% chitosan solution. The sample is gelled, aged for one day and ambient dried. The composite shows reversible swelling in response to pH changes. The following are results of swelling tests.

| | Time (hr.) | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Ph | 5 | | | 8 | | | 5 | | | 8 | | |
| Swelling | 4.5 | 5 | 5.2 | 1.4 | 1.1 | 1.0 | 3.5 | 4.5 | 4.9 | 1.8 | 1.3 | 1.1 |
| Σ(deviation) | 0.25 | 0.3 | 0.3 | 0.27 | 0.1 | 0.09 | 0.6 | 0.4 | 0.3 | 0.08 | 0.3 | 0.2 |

Chitosan-Based Nanopore Composite from Colloidal Particles

During gelation and surface modification, the interfacial properties are finely tuned so that the prescribed morphology is stabilized either kinetically or thermodynamically. For the synthesis of CSMG, the surfactants of choice simultaneously achieve several tasks, namely achieving compatibility between reaction systems, creating morphology through self-assembly, supporting pore structure against shrinkage, preventing crosslinking of surface silanols, and facilitating the surface modification reaction of silica. Because of the large interfacial area inherent in a nanocomposite system, the choice of solvents and surfactants is precisely balanced to avoid the need for excessive surface compatibilizers.

### Loading Reactive Particles in Silica-Chitosan Composite

In order to load reactive particles such as synthetic HA crystals, the silica-chitosan composite may be made by an in-situ gelation of colloidal silica in the presence of chitosan polymers. The formation of an interpenetrating network between two polymers would be utilized to improve various properties of the composite ranging from mechanical strength to chemical stability. Additionally, the numerous surface hydroxyl groups of silica can be modified with ligand groups to moderate the chemical environment.

In order to achieve reactive particle loading by entrapment, an adequate amount of the desired reactive particles are mixed uniformly with chitosan and the colloidal particles prior to gelation. Otherwise, a premature phase separation, even one at micron scale, might later affect adsorption performance capacity adversely. This problem could be induced by any one of several unforeseen interactions among the ingredients, including insufficient solvation, hydrophobic bonding, Coulomb interactions and high interfacial energy.

### Method to Produce CSMG-HA Adsorbent Beads

In this task the goal is to develop methods to prepare composites that encapsulate the HA particles and allowing metal ions to easily flow through the composite to effect good efficiency for removal of Pb. We have investigated several material systems including gelatin and polyacrylamide hydrogels. However, it was found that a silica-chitosan hybrid composite is effective as a binder for the HA powder. Chitosan is a cationic polyelectrolyte due to amino-functionalities it readily associates with the silanol groups of siloxane oligomers, precursors of silica, via hydrogen bonding. The chitosan in effect acts as templating agents for the morphology of the inorganic network. The chitosan polymer also is responsible for the bead formation properties of the pre-gelled mixture. Chitosan solutions can readily be precipitated into bead form and the silica provides added channels for ion diffusion a will as improving the physical properties of the beads. Chitosan is also easily chemically crosslinked and also can adsorb divalent metal ions.

The CSMG-HA absorbent is prepared using the following general examples.

### Example 6

### Part A: Chitosan Solution Preparation

Chitosan powder (16 g, Aldrich Inc., degree of deacetylation 85%, viscosity of 1% chitosan solution in 1% acetic acid of 284 cps) was dispersed in water (380 g). The vigorously stirred dispersion was heated to 50° C. and glacial acetic acid (8 g) was rapidly added to the mixture. Upon addition of the acetic acid, the chitosan dissolves and the viscosity of the solution rapidly increases. The solution is aged for 3 days at 25° C. before use. The concentration of chitosan was approximately 4% wt.

### Part B: Silica Sol Preparation

A silica sol having a tetraethoxysilane (from Gelest Inc.): water: hydrochloric acid mole ratio of 1:23:0.004 was prepared by adding TEOS (50.55 g), deionized water (99.95 g), and 1.01 g of 1 M hydrochloric acid to a 250 ml round neck flask. The mixture was vigorously stirred for 24 hours at a temperature of 25° C. The resultant clear solution had a silica solids content of 10.5% wt.

### Preparation of Composite Beads

To 73.4 g of the chitosan solution (Part A) was added 60.2 g hydroxyapatite crystals (prepared using a method similar to Example 2) suspended in water with a solid content of 11.2% wt.). The mixture was mechanically stirred until a homogeneous solution was obtained, followed by the addition of 70.5 g of silica sol (Part B). The silica sol was well dispersed after an additional 10 minutes of stirring; the mixture was then sonicated for 10 minutes to remove trapped air bubbles. The pH of the mixture was 5.5.

The viscous solution was then pumped and distributed as small drops (3-5 mm diameter) through six thin nozzles into a neutralizing alkaline bath (NH₄OH 0.3 M, pH˜11). The neutralizing bath was equipped with an impeller rotating at low speed that helped prevent the beads from sticking to each other. After 6-12 hour of aging in the solution the beads were collected and thoroughly rinsed with water. The measured solids content of the beads was 14.2% wt. The calculated dry composition (by weight) of the beads is 43.2% silica, 17.4% chitosan and 39.4% hydroxyapatite.

### Example 7

### Part A: Chitosan Solution Preparation

Chitosan flakes (10 g, Fluka Inc., medium viscosity molecular weight) was dispersed in water (240 g). The vigorously stirred dispersion was heated to 50° C. and glacial acetic acid (5 g) was rapidly added to the mixture. Upon addition of the acetic acid, the chitosan begins to dissolves and the viscosity of the solution increases. The solution is aged for 5 days at 25° C. and forms a clear pale yellow solution. The concentration of chitosan was approximately 3.9% wt.

### Part B: Silica Sol Preparation

Sodium silicate (PQ Corporation, N type, SiO₂: NaO=3.22:1) was diluted with deionized water to 11.5% wt. solid content. A silica sol was prepared by adding the diluted sodium silicate solution (67.7 g) to a vigorously stirred solution of nitric acid (13.4 g, 5.78M) with the final pH of the solution adjusted to 1.8 by the drop wise addition of 1 g diluted sodium silicate solution. The acidified sodium silicate sol was aged for 3 days at 4° C. The resultant clear solution had a silica solids content of 7.5% wt. Beads made from solution that have ‘aged’ sodium silicate component are stronger then using the freshly made acidified sodium silicate solution.

### Preparation of Composite Beads:

The composite hybrids were prepared by mixing the aged solutions of chitosan and silica sol and adjusting the pH of the mixture with addition dilute acetic acid followed by addition of the hydroxyapatite slurry prepared using a method similar to Example 2.

To 75.0 g of the chitosan solution (Part A) was added 6.0 g of 0.9M acetic acid followed by 64.0 g of the aged acidified sodium silica sol (Part B). The mixture was mechanically stirred until a homogeneous solution was obtained. While continuing to stir the mixture, the slurry of hydroxyapatite crystals with a solid content of 16.2% wt. was added (31.6 g). The hydroxyapatite was well dispersed after additional 10 minutes of stirring; the mixture was then sonicated for 10 minutes to remove trapped air bubbles. The pH of the mixture was 4.8-5.0. The mixture was used immediately for formation of the beads; the pot life before the mixture gelled was between 30-45 minutes.

The viscous solution was then pumped and distributed as small drops (3-5 mm diameter) through six thin nozzles into a neutralizing alkaline bath (NH₄OH 0.3 M, pH˜11). The neutralizing bath was equipped with an impeller rotating at low speed that helped prevent the beads from sticking to each other. After 12-24 hour of aging in the solution the beads were collected and thoroughly rinsed with water. The measured solids content of the beads was 11.4% wt. The calculated dry composition (by weight) of the beads is 42.1% silica, 25.6% chitosan and 32.4% hydroxyapatite.

### Example 8

### Part A: Chitosan Solution Preparation

Chitosan powder (16 g, Aldrich Inc., degree of deacetylation 85%, viscosity of 1% chitosan solution in 1% acetic acid of 284 cps) was dispersed in water (380 g). The vigorously stirred dispersion was heated to 50° C. and glacial acetic acid (8 g) was rapidly added to the mixture. Upon addition of the acetic acid, the chitosan dissolves and the viscosity of the solution rapidly increases. The solution is aged for 3 days at 25° C. before use. The concentration of chitosan was approximately 4% wt.

### Part B: Silica Sol Preparation

Sodium silicate (PQ Corporation, N type, SiO₂:NaO=3.22:1) was diluted with deionized water to 12% wt. solid content. A silica sol was prepared by adding the diluted sodium silicate solution (78 g) to a vigorously stirred solution of nitric acid (14.4 g, 5.78M) with the final pH of the solution adjusted to 1.8 by the drop wise addition of 1 g diluted sodium silicate solution. The acidified sodium silicate sol was aged for 3 days at 4° C. The resultant clear solution had a silica solids content of 7.7% wt.

### Preparation of Composite Beads:

The composite hybrids were prepared by mixing the aged solutions of chitosan and silica sol and adjusting the pH of the mixture with addition dilute acetic acid followed by addition of the hydroxyapatite slurry prepared using a method similar to Example 2.

To 104 g of the chitosan solution (Part A) was added 8.3 g of 0.9M acetic acid followed by 93.4 g of the aged acidified sodium silica sol (Part B). The mixture was mechanically stirred until a homogeneous solution was obtained. While continuing to stir the mixture, 42.6 g hydroxyapatite crystals dispersed in water with a solid content of 16.2% wt. was added. The hydroxyapatite was well dispersed after additional 10 minutes of stirring; the mixture was then sonicated for 10 minutes to remove trapped air bubbles. The pH of the mixture was 4.8-5.0. The mixture was used immediately for formation of the beads; the pot life before the mixture gelled was between 45-60 minutes.

The viscous solution was then pumped and distributed as small drops (3-5 mm diameter) through six thin nozzles into a neutralizing alkaline bath (NH₄OH 0.3 M, pH˜11). The neutralizing bath was equipped with an impeller rotating at low speed that helped prevent the beads from sticking to each other. After 6-12 hour of aging in the solution the beads were collected and thoroughly rinsed with water. The measured solids content of the beads was 15% wt. The calculated dry composition (by weight) of the beads is 39.6% silica, 22.8% chitosan and 37.6% hydroxyapatite.

### Demonstration of Capacity and Efficiency of Composite Beads

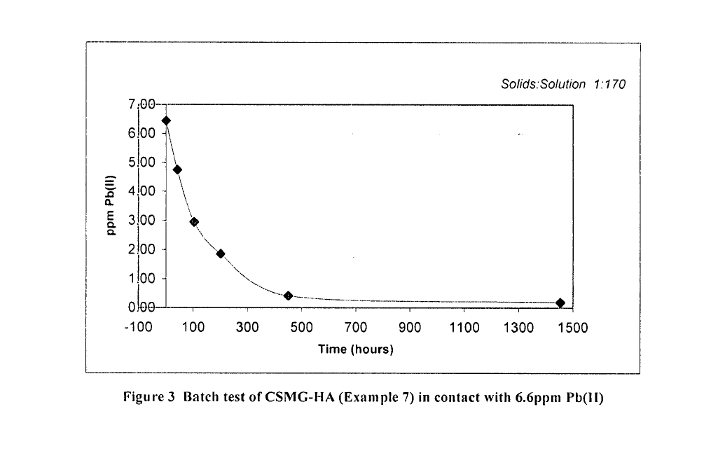

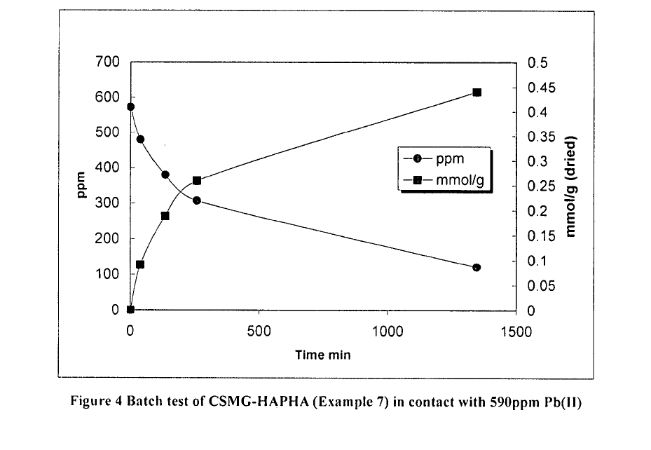

The composites as prepared have good lead absorption properties and use low-cost materials. Batch experiments to determine lead uptake were performed on the CSMG-HA composites using an initial concentration of Pb(II) of 6 ppm and 590 ppm and shown in FIG. 3 and FIG. 4, respectively.

What is claimed is:

1. An adsorbent composition comprising:
a chemically surface modified gel; and
at least one reactive component comprising at least one hydroxyapatite (HA) crystal, HA particle, or component comprising HA.

2. The composition of claim 1, wherein at least one reactive component is at least partially bound to or embedded in the nanocomposite.

3. The composition of any of claims 1-2, wherein at least one reactive component comprises an inorganic crystal.

4. An adsorbent composition comprising:
a nanocomposite comprising chitosan polymer encapsulated in surface modified colloidal nanoporous nanoparticles; and
at least one reactive component.

5. The composition of claim 4, wherein at least one reactive component comprises HA.

6. An ion-exchange adsorbent composition, comprising:
a nanopore host substrate; and
inorganic nanocrystals embedded within the nanopore host substrate.

7. The composition of claim 6, wherein cationic and/or anionic sites at the surface of the inorganic nanocrystal capture ions with similar charge to size ratios.

8. The composition of claim 6 or 7, wherein the inorganic component comprises HA.

9. A method of recovering a metal ion from a fluid, comprising contacting the fluid with the composition of any of claims 1-8.

10. The method of claim 9, wherein the metal ion is selected from the group consisting of lead, copper, cadmium, mercury.

11. A method of treating lead-containing waste under a near neutral pH (i.e. between 6-8) condition, comprising contacting the waste with the composition of any of claims 1-8.

12. A method of treating lead ions in effluent waste, following the precipitation of Pb(OH)₂ by a strong base, comprising contacting the waste with the composition of any of claims 1-8.

13. A method of stabilizing Pb(OH)₂ precipitate at a site, comprising contacting at least a portion of the site with the composition of any of claims 1-8.

14. The method of claim 13, wherein the site is a landfill or abandoned mine sites.

15. A method of preventing lead ions from leaching from a site, comprising contacting at least a portion of the site with the composition of any of claims 1-8.

16. A method for at least partially immobilizing lead ions in or on soil and/or maintaining a neutral soil condition, comprising contacting the soil with the composition of any of claims 1-8.

17. A method for forming a reactive barrier to prevent lead ions from diffusing into water streams or plant roots, comprising using the composition of any of claims 1-8.

18. A method for removing heavy metal ions from tap or drinking water, comprising contacting the water with the composition of any of claims 1-8.

19. A method for forming a reactive barrier coating over lead paint and preventing lead ion leaching from the paint, comprising contacting at least a portion of the paint with the composition of any of claims 1-8.

20. A process of recovering metal ions from a low-concentration, spent solution by using nanopore reactive adsorbent of which the reactive component is composed of inert electrodes and the adsorption component is a CSMG nanopore substrate coated on the electrode; wherein at least one ligand in the CSMG coating adsorbs and/or catalyzes the nucleation of a metal ion.

21. The process of claim 20, wherein the metal ion is selected from silver, gold, platinum and palladium.
